(19) United States
(12) Patent Application Publication
(10) Pub. No.: US 2019/0305932 A1
(43) Pub. Date: Oct. 3, 2019

(54) DISTRIBUTED KEY MANAGEMENT AND ENCRYPTION FOR BLOCKCHAINS

(71) Applicant: Townsend Security, Inc., Olympia, WA (US)

(72) Inventor: Patrick Townsend, Olympia, WA (US)

(21) Appl. No.: 15/942,365

(22) Filed: Mar. 30, 2018

(51) Int. Cl. H04L 9/06; H04L 9/08; H04L 9/00; H04L 9/32

(52) U.S. Cl. CPC H04L 9/0637; H04L 9/0819; H04L 9/3265; H04L 9/006; H04L 9/085

(57) ABSTRACT

Techniques for enhancing the security and privacy of blockchain are described. One approach implements a blockchain encryption management system. The system includes multiple nodes that are each configured to integrate encryption-related services with a distributed blockchain ledger. The consensus mechanism of the blockchain ledger is used to communicate information, requests, and responses about encryption-related functions performed throughout the system. For example, a new encryption key can be transmitted from a first node to a second node by securely recording the key in the blockchain ledger. The key is communicated to the second node via the blockchain consensus mechanism. This key can then be used by the second node to encrypt the contents of a transaction that is recorded in blockchain ledger, thereby providing privacy to the parties to the transaction.

### TECHNICAL FIELD

The present disclosure relates to techniques for integrating distributed key management and encryption with blockchain technology.

### BACKGROUND

Blockchain is a technology for implementing an open, distributed ledger that can record transactions between parties in an efficient, verifiable, and permanent manner. Blockchain relies on a continuously growing list of blocks that are cryptographically linked to one another. In typical implementations, each block contains transaction data, time information, and a link to a previously created block. The link may be represented as a hash (e.g., message digest) based on the contents of the previous block, thereby creating a secure link that renders the contents of the previous block tamper-proof. Because each block includes a secure link to a previous block, a sequence of blocks forms a secure “chain” of blocks. The contents of any given block can be validated by comparing the link to the block with a hash of the contents of the block. If the two values do not match, then the block has been modified and is therefore not valid.

In typical implementations, the blockchain is replicated across multiple network nodes. Transactions are broadcast across the network. Each network node adds transactions to its copy of the blockchain and assures the integrity of the chain. A consensus mechanism is employed to assure that the blockchain is consistent across the network of nodes. Digital signature schemes are typically employed to assure the authenticity of transactions.

While blockchain provides a robust mechanism for securely recording transactions, it does suffer from some technical shortcomings. As one example, blockchain transactions recorded in the blockchain ledger are provably accurate (e.g., they cannot be modified or deleted), but they are not private. That is, all information written to the blockchain is in the clear. This technical limitation inhibits the use of blockchain for many types of transactions, and presents privacy and compliance challenges. For example, for purposes of customer relations and/or legal compliance, a bank must assure that funds transfers, stock purchases, or similar transactions do not disclose certain information about the transaction, such as the names or addresses of the parties. In another context, blockchain could be used to track the distribution of food from source to consumer. While employing blockchain in this manner promises to enhance food safety and streamline the food recall process, it would also expose confidential business information, such as business relationships between suppliers and distributors, production volumes, and the like.

### BRIEF DESCRIPTION OF THE DRAWINGS

Preferred and alternative examples of the present invention are described in detail below with reference to the following drawings.

FIG. 1 is a block diagram that illustrates the functional components of an example embodiment.

FIG. 2 is a block diagram that illustrates a blockchain encryption management system according to an example embodiment.

FIG. 3A is a flow diagram that illustrates a key management and encryption auditing process according to an example embodiment.

FIG. 3B is a flow diagram that illustrates a key distribution process according to an example embodiment.

FIG. 3C is a flow diagram that illustrates a key deletion process according to an example embodiment.

FIG. 4 is a flow diagram that illustrates a blockchain encryption management process performed by example embodiments.

FIG. 5 is a block diagram that illustrates a computer system that implements a system node according to an example embodiment.

### DETAILED DESCRIPTION

This disclosure presents techniques for blockchain distributed key management and encryption. In some embodiments, the described techniques provide a blockchain encryption management system (“BEMS”). The BEMS addresses many of the above-described privacy problems with prior art blockchain technologies. The BEMS provides a blockchain fabric with professional key management services, distribution of encryption keys (symmetric, asymmetric, and certificates) across all or selected blockchain nodes using the distributed blockchain ledger, and granular encryption key access controls. Key management and encryption service functions utilize blockchain smart contracts (also referred to as “chaincode”) and fabric applications to perform secure distribution of encryption keys and access policies.

The BEMS provides the ability to secure information in blockchain ledgers and associated data stores using industry standard encryption, while storing encryption keys outside of the ledger. This solution combines professional and compliant key management through a generalized, pluggable interface with the distributed services of blockchain ledgers with a user interface based on web REST (“Representational State Transfer”) services and JavaScript Object Notation Remote Procedure Calls (“JSON/RPC”). Blockchain users and developers can use common programming interfaces (“APIs”) to implement strong key management and encryption services in a fully distributed blockchain environment.

Some embodiments provide an application layer, or fabric, that integrates users and applications with a key management solution, web interfaces based on REST and JSON/RPC services, and blockchain distributions to provide a fully distributed key management solution for blockchains. Prior to the described techniques, organizations have struggled with legacy encryption key management solutions that do not match the distributed and consensus model of blockchain. With the described techniques, organizations can now fully implement data privacy for blockchains using an encryption key management method that fully integrates with distributed blockchains and leverages the consensus and distributed technologies inherent in blockchain.

Using the described techniques, users and applications have access to a variety of encryption key management, encryption, decryption, and certificate management functions through industry standard secure web services based on REST and JSON/RPC. These secure interface mechanisms make it easy and inexpensive to deploy industry standard encryption key management and encryption services which naturally follow the blockchain architecture.

In the BEMS, encryption keys are distributed across blockchain nodes as they are created or as they are needed through either a real-time or on-demand architecture. The method of distribution typically relies on the blockchain ledger and smart contracts (chaincode). The smart contracts detect encryption key operations and integrate with local key managers to perform a variety of functions. The use of the blockchain ledger as a part of key distribution operations helps ensure authorized and authenticated transactions, rapid distribution across a blockchain network of nodes, and a consensus model for key distribution.

In order to support a variety of key management solutions, the BEMS typically supports a pluggable module approach to key management based on the industry standard OASIS Key Management Interoperability Protocol (“KMIP”) or other proprietary key management system interface.

Because all key management, encryption, decryption, and authority operations are logged to the blockchain ledger, there is an immutable audit trail of security information for these functions. This provides an enhanced layer of confidence and transparency in key management, encryption, and privacy transactions.

The described techniques can be implemented on private or public blockchains with a wide range of nodes and consensus mechanisms. Users will achieve a better security posture related to data privacy and will ensure the use of compliant cryptographic algorithms.

The described techniques are unique and distinct in at least the following ways. First, encryption key distribution is accomplished using native blockchain ledger functions and the inherent blockchain consensus method. Encryption key distribution relies on the blockchain proof-of-work, proof-of-stake, or other consensus mechanism to ensure integrity of all key management operations.

In addition, distribution of encryption keys through the native blockchain ledger is protected through the use of temporary, or ephemeral, asymmetric keys. Ephemeral keys protect encryption keys through the distribution process and are deleted on successful completion of distribution. This effective zeroizes key material in the blockchain ledger, thereby providing an enhanced level of security.

Furthermore, key management activity is logged to the blockchain ledger providing an immutable audit trail of key management activity. This enhances the strength of audit activity for key management. Because key management activity leverages the native an inherent distributed nature of blockchains, user can scale key management functions across large numbers of distributed blockchain nodes.

In some embodiments, the BEMS also provides a secure, authenticated Transport Layer Security (“TLS”) web interface to key management and encryption functions to enhance the security of blockchain key management transactions. The REST and JSON/RPC interfaces provide an easy-to-use API that is familiar to blockchain developers.

### Functional Overview

Embodiments of the BEMS implement a number of common encryption key management services through its REST and/or JSON/RPC application program interfaces (APIs). One embodiment of the BEMS includes the following functions. Other embodiments may provide a different combination of functions that are configured to provide the same or similar services related to the management and use of encryption keys.

Create Encryption Key

Using a TLS secure web interface, create a symmetric AES encryption key or an asymmetric RSA encryption key using a National Institute of Standards and Technology (“NIST”) compliant implementation of key establishment. Encryption keys are created in the key management system and stored using NIST-compliant methods. Attributes of the key such as the name, version, ownership, and other information is written to the blockchain ledger. Other nodes can use the ledger and smart contracts to request the key for import to the local version of the key manager.

Import Encryption Key

Using a TLS secure web interface, import a symmetric Advanced Encryption Standard (“AES”) encryption key or an asymmetric Rivest-Shamir-Adleman (“RSA”) encryption key into a NIST-compliant implementation of key management. Keys are stored and protected using NIST-compliant methods. Attributes of the key such as name, version, ownership, and other information is written to the blockchain ledger. Other nodes can use the ledger and smart contracts to request the key for import to the local version of the key manager.

Retrieve Encryption Key

Using a TLS secure web interface, retrieve an encryption key from the key manager. Authority to the key is determined by inspecting the blockchain ledger for appropriate authority. The key is retrieved from the key manager and returned to the requesting user. For on-demand key distribution if the key is not available in the current node's key manager, the blockchain ledger is inspected to determine the originating node for the key, and a request is made via the blockchain ledger and smart contracts to receive the key. The key retrieval request is noted in the blockchain ledger for audit purposes.

Delete Encryption Key

Using a TLS secure web interface receive a request to delete a key from the key manager. Delete the key from the key manager and record the event to the blockchain ledger. Remote nodes use smart contracts and application fabric APIs to delete the key from node key managers.

Grant Authority to Encryption Key

Using a TLS secure web interface, grant authority to a node or user to use a specific key. The authorization event is written to the blockchain ledger and the information is distributed to remote blockchain nodes using normal distributed ledger mechanisms.

Revoke Authority to Encryption Key

Using a TLS secure web interface, revoke authority from a node or user to use a specific key. The revocation event is written to the blockchain ledger and the information is distributed to remote blockchain nodes using normal distributed ledger mechanisms.

Import and Export of Certificates

Public Key Infrastructure (“PKI”) certificates are common ways that encryption keys and related policies are distributed to parties that need them. This solution provides a method to import and export certificates for users and applications that need them. Using a TLS secure web interface PKI certificates of any type can be stored in the key manager and made available to users, applications and smart contracts that need them.

Real-Time and On-Demand Key Distribution

The BEMS supports both real-time and on-demand encryption key distribution. When in real-time mode the distribution of keys is effected in near real time. Smart contracts on remote nodes inspect the blockchain ledger, detect new keys, and make a request from the originating node to receive the key. This option enables the use of encryption keys as they are needed across a wide number of distributed blockchain nodes.

When in on-demand mode, encryption keys are requested from the originating node as they are needed and if they do not already exist in the local node's key manager. The blockchain ledger is inspected to determine the location of a key, the key is requested via the ledger, and the received key is added to the local key manager. On-demand key distribution works better where blockchain consensus methods impose a performance penalty on the use of the ledger, or where key distribution is not needed to meet application performance requirements.

Distribute Encryption Key with Blockchain Ledger

When encryption keys are created or imported to a key manager on a blockchain node, information about the key is written to the blockchain ledger. Using normal blockchain distribution and consensus methods, the information about the key is transferred to all other nodes. If remote nodes are performing real time key distribution, a smart contract (chaincode) detects the new key event and starts a sequence of requesting the key via the blockchain ledger. Upon receipt of the key in the response the key is imported to the key manager at that node and key material is cryptographically zeroized in the ledger.

If remote nodes are performing on-demand key distribution, no key synchronization activity is performed at the time the key is created or imported. Instead, if a key is needed at a remote node and it does not already exist in the local node's key manager, it is requested at the time. The key synchronization process via the ledger uses the same mechanism as the real-time key synchronization process.

Distribute Encryption Key with P2P Message

As an alternative to blockchain ledger distribution of keys, a secure Point-to-Point (“P2P”) messaging facility is implemented. The P2P messaging facility is implemented as a TLS secured web interface between one or more blockchain nodes.

Distribute Encryption Key with Shared Storage

As an alternative to blockchain ledger distribution of keys, a secure storage mechanism is implemented. The secure storage mechanism is shared between multiple blockchain nodes. An encryption key to be distributed is encrypted and then written to the shared storage mechanism. Blockchain ledger entries and smart contracts are then used to request and receive the key via the shared storage. All exchanged keys are protected with strong encryption.

Ephemeral Encryption Keys

Ephemeral encryption keys are temporary keys that are only used for the protected transfer of keys among nodes on the blockchain. An ephemeral key is only used to transport one encryption key to one other blockchain node. An ephemeral key is deleted after an encryption key is transferred, or after a user-specified lease time. The deletion of the ephemeral key effectively zeroizes the cryptographic key material remaining in the blockchain ledger or shared storage.

Encryption Services

In order to leverage the enhanced security of the key manager, encryption and decryption services are provided by the key manager. Using a TLS secure web interface a user or application can request that data be encrypted or decrypted using the key manager service. Encryption keys used for encryption and decryption do not leave the key manager as a part of the service. All encryption and decryption operations are logged to the blockchain ledger for audit.

Representational State Transfer (REST) Web Application Interface

Users and applications may interact with the key management and encryption services through a TLS secure REST interface. This provides a standard interface to the services that is secured by TLS authentication and encryption.

JSON/RPC Application Interface

Users and applications may interact with the key management and encryption services through a TLS secure JavaScript Object Notation Remote Procedure Call interface. This provides a standard interface to the services that is secured by TLS authentication and encryption.

Smart Contracts (Chaincode)

Smart contracts implemented through blockchain chaincode provide a number of application services including authentication, integration between the blockchain and the key manager, blockchain ledger query functions, automated processing, and other common smart contract functions. Smart contracts may be implemented in a variety of programming languages and functionality may vary between different blockchain distributions.

### System Overview and Processes

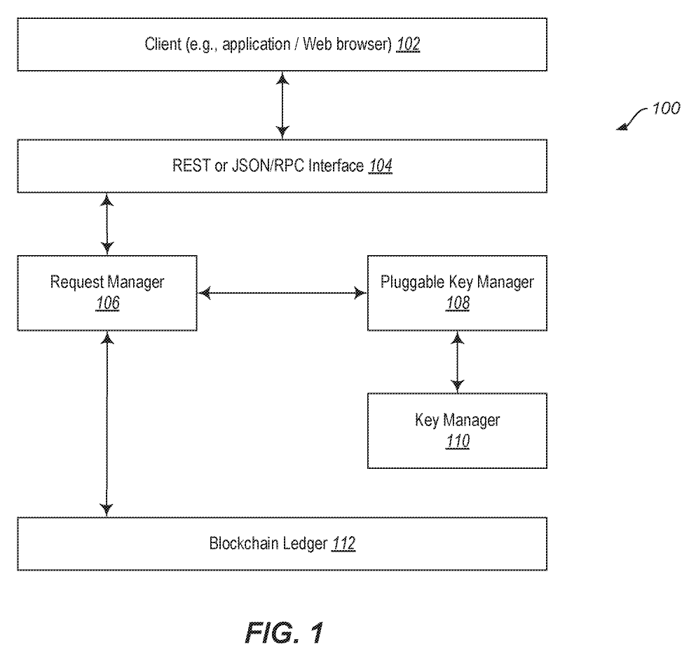

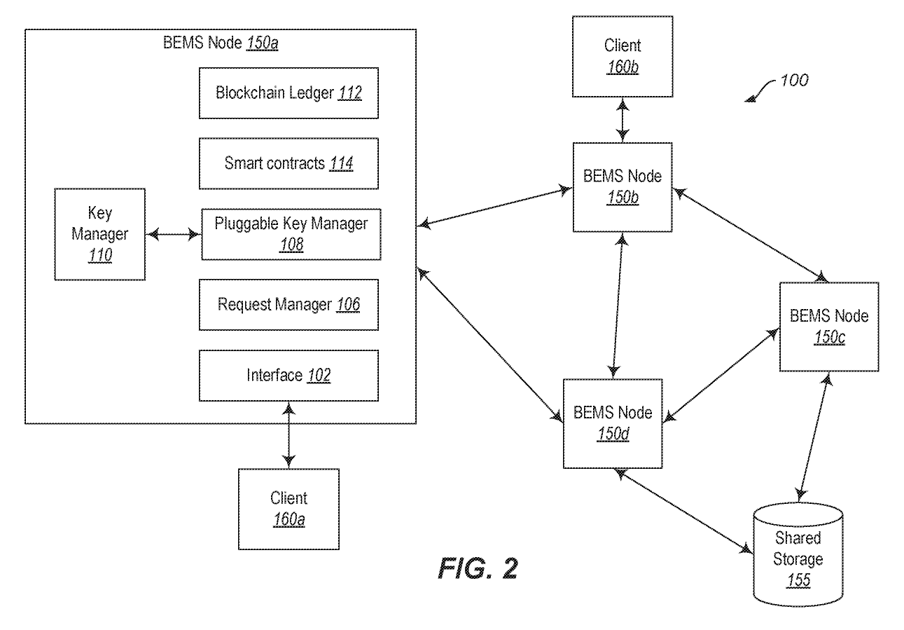

FIGS. 1 and 2 are block diagrams that depict functional components and their structural organization into an example Blockchain Encryption Management System (“BEMS”). In particular, FIG. 1 shows the functional components of an example BEMS 100. The BEMS 100 includes a client 102, an interface 104, a request manager 106, a pluggable key manager 108, a key manager 110, and a blockchain ledger 112.

The client 102 may be or include an application, a Web browser or similar. The client performs encryption-related operations by communicating with the interface 104. The interface 104 may interact with the client 102 via REST, JSON, and/or RPC. Other or additional remote interaction protocols/formats are contemplated, including BSON, XML, RMI, or the like.

The request manager 106 receives requests from the interface 104. Such requests typically require interacting with the pluggable key manager 108 and/or the blockchain ledger 112. For example, if the request manager 106 receives from the interface 104 a request to create a new encryption key, the request manager 106 instructs the pluggable key manager 108 to create a new key. The pluggable key manager 108 operates as a “virtual” key manager that provides an interface to a key manager 110. The pluggable key manager 108 provides a uniform interface such that key managers from different vendors may be employed.

When the request manager 106 performs an operation, it stores an audit record of that operation in the blockchain ledger 112. For example, if the request manager 106 creates a new key, the manager records information about that new key in the ledger 112. Other nodes in the system are then automatically updated via a blockchain consensus mechanism that is employed by the particular blockchain implementation in use.

The request manager 106 also performs operations based on data received from the blockchain ledger 112 via chaincode. For example, the manager 106 may learn from the ledger 112 that some other node has deleted an encryption key. The request manager 106 learns this because a manager executing on the remote node made a record of the operation in the ledger 112, which in turn notifies the request manager 106 via the ledger consensus mechanism. The manager 106 will then locally perform a corresponding operation (e.g., delete the key in the key manager 110).

FIG. 2 is a block diagram that illustrates the structural arrangement of a BEMS 100 according to one embodiment. Here BEMS 100 includes nodes 150a-150d. Each of these nodes 150a-150d is typically a distinct computing system or cloud instance. Node 150a, which is representative of all of the illustrated nodes, includes an interface 102, a request manager 106, a pluggable key manager 108, a key manager 110, a blockchain ledger 112, and smart contracts 114. The BEMS 100 further includes clients 160a and 160b, and a shared storage system 115. The clients 160 may be applications, computing systems, Web browsers, or the like that request encryption-related services from the nodes 150. Note that in some embodiments, one or more of the components of a given node 150 may execute externally to the node. As one example, the key manager 110 could execute outside of node 150a, and communicate with the pluggable key manager 108 via a secure network connection.

The smart contracts 114 are chaincode that executes based on events detected in the blockchain ledger 114 and/or the node 150a itself. For example, one of the smart contracts 114 may detect, via the ledger 112, that node 150b has created a new key. This operation may be based, for example, on a request to create a new key made by a client 160b. When node 150b creates a new key, it records this fact in its own copy of the blockchain ledger. The ledger's consensus protocol then transmits this information to other nodes 150a, 150c, and 150d, where respective smart contracts perform corresponding operations. In the case of creating a new key, the key may be obtained via the ledger, point-to-point communication, and/or shared storage 155, as discussed above.

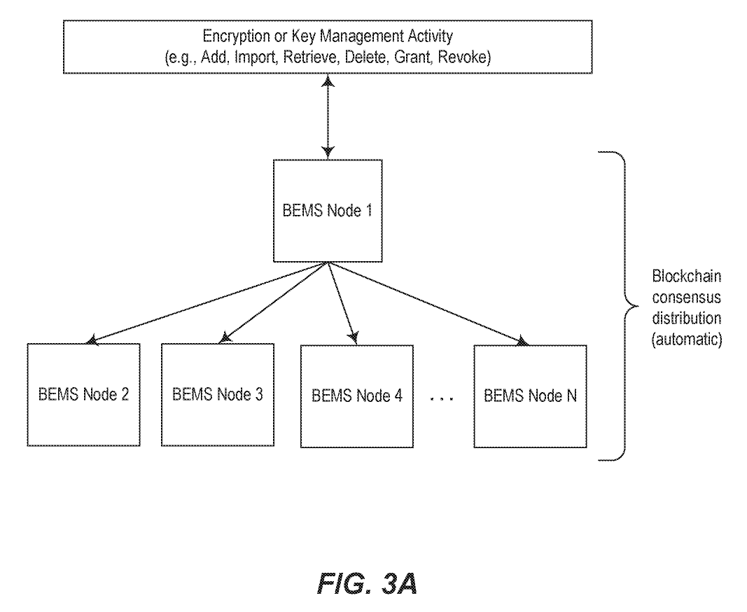

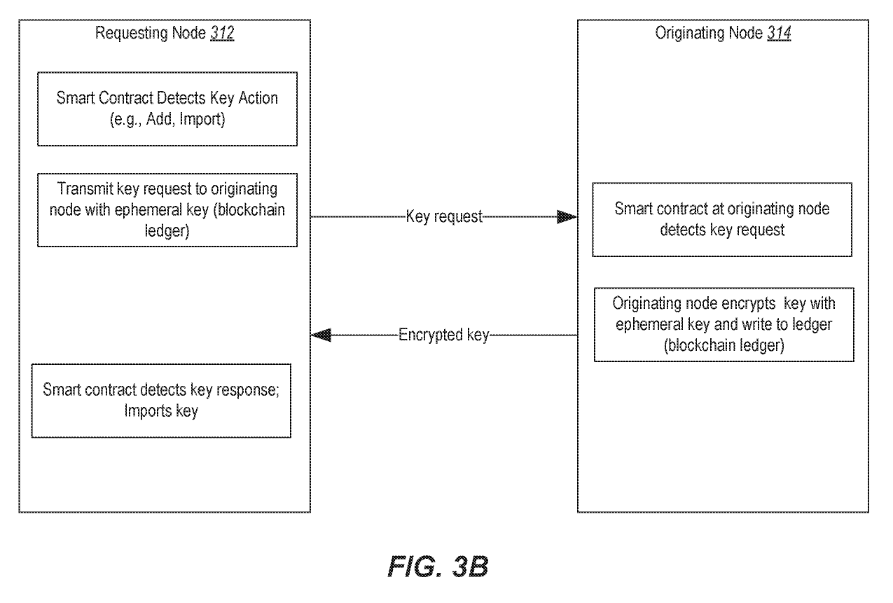

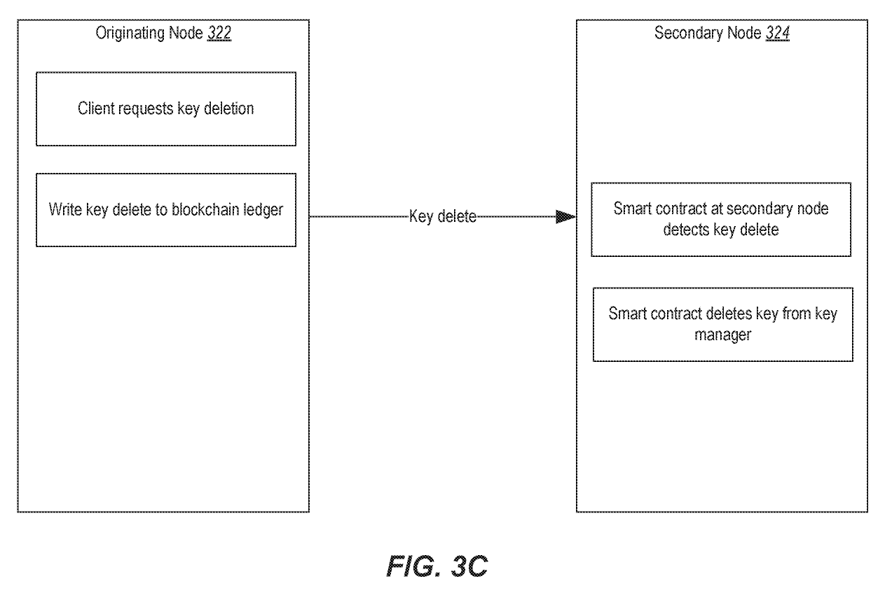

FIG. 3A is a flow diagram that illustrates a key management and encryption auditing process according to an example embodiment. FIG. 3A illustrates the use of blockchain consensus distribution to notify other nodes of an encryption key or encryption-related operation. In this example, node 1 is notified of an activity (e.g., an add, import, delete, grant, revoke). Node 1 then passes this information to nodes 2-N by recording an indication of that activity in its local copy of the blockchain ledger. That indication is then communicated to nodes 2-N by operation of the blockchain's consensus mechanism.

FIG. 3B is a flow diagram that illustrates a key distribution process according to an example embodiment. In this example, a requesting node 312 obtains a new key from an originating node 314. First, a smart contract on the requesting node 312 detects, via the blockchain ledger, that the originating node 314 has performed a key action, such as an add, create, or import.

The requesting node 312 then transmits a request for the key to the originating node along with an encrypted ephemeral key. As discussed above, this request may be made by recording it in the blockchain ledger, by transmitting a point-to-point message, or using shared storage. In this example, a key request is made by the requesting node 312 via the blockchain ledger. A smart contract on the originating node 314 detects the request in the ledger. Then, the originating node 314 encrypts the key with the ephemeral key, and records the encrypted key in the blockchain ledger. The smart contract on the requesting node 312 then receives the encrypted key by the consensus mechanism of the blockchain ledger. The smart contract on node 312 then decrypts the key, imports it into its local key manager, and deletes the ephemeral key.

FIG. 3C is a flow diagram that illustrates a key deletion process according to an example embodiment. In this example, a client on an originating node 322 requests a key deletion event. This could occur, for example, because a user of the node 322 deletes the key. The node 322 then writes the key delete operation to the blockchain ledger, thereby notifying blockchain nodes, including secondary node 324. When a smart contract on node 324 learns of the key deletion, it instructs a key manager associated with node 324 to delete the key.

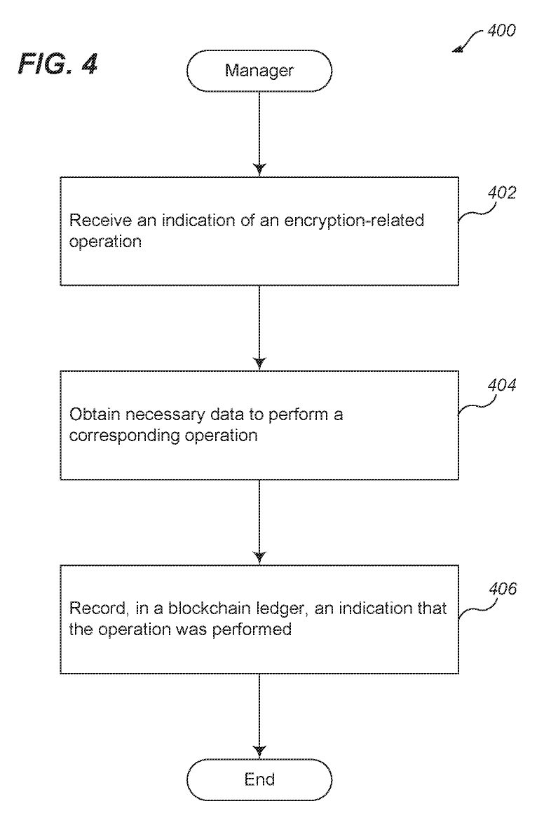

FIG. 4 is a flow diagram that illustrates a blockchain encryption management process 400 performed by example embodiments. The process 400 may be performed by one or more of the request manager 106, the smart contract chaincode 114, and/or some combination thereof as described above.

The process 400 begins with block 402, where it receives an indication of an encryption-related operation. This indication may be from a blockchain ledger, where the indication identifies an operation performed by some remote node, such as a new encryption key being created on the remote node. Alternatively, this indication may be from a local request, such as a Web browser or other application requesting the creation of a new encryption key.

In block 404, the process obtains the necessary data to perform a corresponding operation. When the operation is one performed on a remote node, the process obtains the necessary data to perform the operation locally, which may entail communicating (directly or indirectly) with the remote node. As discussed above, the process may communicate with the remote node via the blockchain ledger, point-to-point communication, or shared storage. For example, if the operation is that a remote node created a new key, the process may record a request for the key in the ledger along with an ephemeral key. The remote node will then encrypt the key with the ephemeral key, and record the encrypted key in the ledger.

When instead the operation is based on a local request, the process obtains any additional information and then (typically) interacts with a key manager to perform the operation. For example, if a local Web client is requesting a new key, the process obtains a new key from the key manager and provides it to the Web client.

In block 406, the process records, in a blockchain ledger, an indication that the operation was performed. By recording the indication in the ledger, the process creates an audit trail and notifies other nodes of the operation so that they may take corresponding action. As discussed above, other nodes are notified via the consensus mechanism employed by the blockchain ledger.

### Example Computing System Implementation

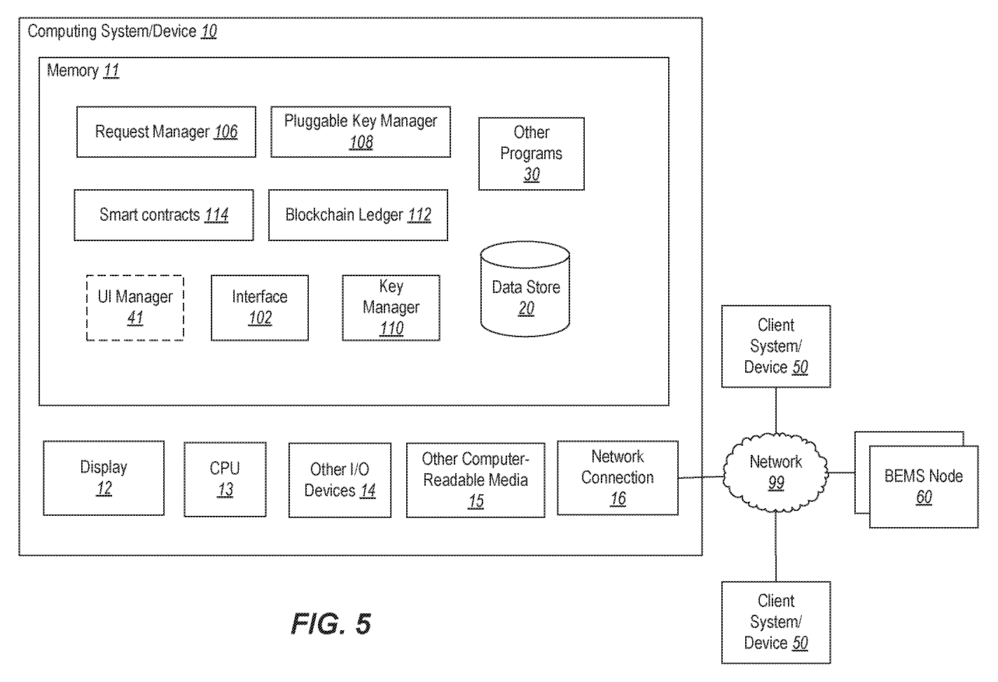

FIG. 5 is a block diagram that illustrates a computer system that implements a system node according to an example embodiment. In particular, FIG. 5 shows a computing system or device 10 that may be utilized to implement a Blockchain Encryption Management System node, such as node 150 described with respect to FIG. 2, above.

Note that one or more general purpose or special purpose computing systems/devices may be used to implement the BEMS. However, just because it is possible to implement the BEMS on a general purpose computing system does not mean that the techniques themselves or the operations (taken alone or in combination) required to implement the techniques are conventional or well known.

In the embodiment shown, computing system 10 comprises a computer memory (“memory”) 11, a display 12, one or more Central Processing Units (“CPU”) 13, Input/Output devices 14 (e.g., keyboard, mouse, CRT or LCD display, and the like), other computer-readable media 15, and network connections 16. Modules of the BEMS (including modules 102, 106, 108, 110, 112, 114) are residing in memory 11. In other embodiments, some portion of the contents, some or all of the components of the BEMS may be stored on and/or transmitted over the other computer-readable media 15. The BEMS modules preferably execute on one or more CPUs 13 and performs the techniques described herein. Other code or programs 30 (e.g., an administrative interface, a Web server, and the like) and potentially other data repositories, such as data repository 20, also reside in the memory 11, and preferably execute on one or more CPUs 13. Of note, one or more of the components in FIG. 5 may not be present in any specific implementation. For example, some embodiments may not provide other computer readable media 15 or a display 12.

The BEMS interacts via the network 99 with a client system/devices 50 and multiple other BEMS nodes 60. The network 99 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. The other devices/systems 50 and 60 are constituted similarly to computing system 10.

In an example embodiment, components/modules of the BEMS are implemented using standard programming techniques. For example, the BEMS may be implemented as a “native” executable running on the CPU 13, along with one or more static or dynamic libraries. In other embodiments, the BEMS may be implemented as instructions processed by a virtual machine that executes as one of the other programs 30. In general, a range of programming languages known in the art may be employed for implementing such example embodiments.

The various components may be implemented using more monolithic programming techniques, for example, as an executable running on a single CPU computer system, or alternatively decomposed using a variety of structuring techniques known in the art, including but not limited to, multiprogramming, multithreading, client-server, containers, or peer-to-peer, running on one or more computer systems each having one or more CPUs. Some embodiments may execute concurrently and asynchronously, and communicate using message passing, remote procedure call, or other distributed computing paradigms. Equivalent synchronous embodiments are also supported. Also, other functions could be implemented and/or performed by each component/module, and in different orders, and by different components/modules, yet still achieve the described functions.

In addition, programming interfaces to the data stored as part of the BEMS, such as in the data store 20, can be available by standard mechanisms such as through C, C++, C#, and Java APIs; libraries for accessing files, databases, or other data repositories; through representational languages such as XML; or through Web servers, FTP servers, or other types of servers providing access to stored data. The data store 20 may be implemented as one or more relational or non-relational database systems, distributed or non-distributed file systems, or any other technique for storing such information, or any combination of the above, including implementations using distributed computing techniques.

Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the BEMS may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Various hardware/software implementation and deployment platforms are contemplated, including cloud-based systems, virtual systems, mobile devices (e.g., tablets, smart phones), server computers, desktop computers, or the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

### Example Use Cases

The described BEMS can be used in a number of different contexts to audit and secure blockchain transactions. A number of example use cases are described below in order to provide a fuller understanding of the use of the described BEMS. Other use cases are contemplated, and the invention is in no way limited to these example scenarios.

Bank or Money Service Funds Transfer

Every year millions of individuals and businesses transfer funds between their own accounts, and from their accounts to the accounts of others using traditional banking services or money transfer services. A certain percentage of these transactions are subject to error and loss imposing hardships on the parties and the financial institutions performing the transfers. Blockchain technology has the ability to reduce these errors and provide a provable record of the source and destination of funds. However, sensitive information (e.g., names, addresses, account numbers, phone numbers) about the individuals and businesses may be exposed in blockchain transactions. The use of the BEMS can reduce the potential for exposure of this sensitive information and ensure that only authorized parties can access the information.

Using the BEMS, a typical funds transfer transaction between Business A and B may include the following steps:
1. Business A creates an encryption key to be used to protect the transaction.
2. The key is transferred to all other BEMS nodes using smart contracts.
3. Business A uses key management to encrypt its sensitive information.
4. Business A writes a funds transfer transaction to the BEMS blockchain ledger. Source and destination accounts, and the amount are not encrypted. Business A and Business B sensitive information is encrypted.
5. Business A grants authority to Business B to use the encryption key. Only Business B is authorized to decrypt the sensitive information.
6. The BEMS blockchain distributes the funds transfer transaction to all other nodes ensuring the integrity of the transaction.
7. Business B receives the funds transfer.
8. Business B retrieves the encryption key from the local key manager.
9. Business B decrypts the sensitive information in the funds transfer transaction
10. Business B now has a full audit trail for the transaction. All other blockchain users cannot view the sensitive details of the transaction.

Retail Purchase

Consumers make millions of purchases at brick-and-mortar stores and on Internet eCommerce sites. Information that they provide during a purchase is retained by the retailer who generally provides little capability to the consumer to share that information with others. The benefit of the purchase information is retained by the retailer. Through the use of the BEMS, retail purchase information can be controlled by the consumer. This gives the consumer the potential to benefit by sharing that information with other retailers, with rewards programs, and so forth. Central to the ability to control this information is the ability to protect it with strong encryption and key management for the blockchain.

Using the BEMS, a typical retail transaction may include the following steps.
1. Consumer A makes a purchase at a retail store or online.
2. Consumer A uses a mobile application to manually or automatically write the transaction to the BEMS blockchain. An encryption key is used to protect consumer information. The key is transferred to all other blockchain nodes using smart contracts. Purchase and consumer information is encrypted. Purchase and consumer information is written to the blockchain ledger.
3. Consumer A wishes to participate in another retailer's loyalty program.
4. Consumer A grants the right to use the encryption key to the other retailer.
5. Consumer A benefits from the loyalty program. Consumer A may revoke the right of access at any time in the future by using the key management solution.
6. Consumer A and the loyalty program owner have full access to an audit log. All other blockchain users cannot view the purchase details of the transaction.

Food Safety

Every year food-borne illness affects thousands of people. When cases of suspected food contamination surface it is a daunting task to identify the source of contaminated food, and where it has landed on shelves in the food distribution network. It can take weeks to fully investigate a case of food contamination. Blockchain technologies are being proposed to track food from “farm to table”. Leveraging the secure audit facilities of the blockchain ledger this has the potential of greatly reducing the time to discover the source of food contamination and mitigate its impacts. However, providing an audit trail of the food production and distribution network involves the sharing of highly confidential information across many participants in the food supply chain. Networks of suppliers, distributors, and transporters of food consider their business relationships private and central to their operations. Using the BEMS to protect sensitive information on food safety blockchain networks provides a way of sharing information critical to food safety without exposing business-critical information.

Using the BEMS, a food safety transaction flow may include the following steps.
1. Farm operator A harvests lettuce from a farm F.
2. Farm operator A assigns a unique crate identifier for the lettuce.
3. Farm operator A creates a new encryption key for tracking this crate of lettuce. The key is transferred to all nodes in the BEMS blockchain.
4. Farm operator A writes a food safety record to the BEMS blockchain. The food type (lettuce) and crate identifier are not encrypted. The farm operator information, geographic location, and other sensitive information are encrypted.
5. The BEMS blockchain is used to record the transit of the crate. The crate of lettuce is delivered to a processing facility, which is recorded in the BEMS blockchain. Then, the lettuce is shipped across country to a store distribution center; another BEMS blockchain transaction is created. The lettuce is delivered to a store; a BEMS blockchain transaction is created. A consumer purchases the lettuce; a BEMS blockchain transaction is created. For all transactions recorded to the BEMS blockchain ledger selected sensitive information is encrypted.
6. A food safety event occurs and a crate identifier is suspected.
7. A request is made for access to the encryption key via the BEMS blockchain.
8. Farm operator A receives the encryption key request.
9. Farm operator A grants authority to the key to federal food safety inspectors.
10. Food safety inspectors decrypt the information using the key and disclose the source of the contamination as farm F. A recall of the lettuce is initiated. All other blockchain users cannot view the farm facility information.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A computing system, comprising:
a memory;
a processor;
a blockchain ledger; and
a local blockchain encryption management module that is stored on the memory and that is configured, when executed by the processor, to:
receive, via the blockchain ledger, an indication of an encryption key management operation, wherein the operation is one of importing the key, creating the key, deleting the key, retrieving the key, granting authority to the key, or revoking authority to the key;
perform the operation with respect to the encryption key; and
record, in the blockchain ledger, an indication that the operation was performed.

2. The computing system of claim 1, wherein the local module is further configured to:
receive, via the blockchain ledger, an indication that a remote blockchain encryption management module executing on a remote computing system has imported or created the key;
obtain the key from the remote module;
store the key in a key manager.

3. The computing system of claim 2, wherein the local module is further configured to obtain the key from the remote module by recording a request for the key in the blockchain ledger,
wherein the remote module is configured to:
receive, via the blockchain ledger, the request for the key;
encrypt the encryption key with an ephemeral key that is unique to the local module; and
transmit, via the blockchain ledger, the encrypted key to the local module.

4. The computing system of claim 3, wherein the remote module receives the ephemeral key from the local module via the blockchain ledger.

5. The computing system of claim 2, wherein the local module is further configured to obtain the key from the remote module by transmitting a first point-to-point message to the remote module, wherein the first message includes a request for the key,
wherein the remote module is further configured to:
receive, via the first point-to-point message, the request for the key;
transmit a second point-to-point message to the local module, wherein the second message includes the encryption key.

6. The computing system of claim 5, wherein the first point-to-point message includes an ephemeral encryption key, and wherein the remote module transmits to the local module the requested key encrypted with the ephemeral key.

7. The computing system of claim 2, wherein the local module is further configured to obtain the key from the remote module by receiving the key from a shared data storage system, wherein the remote module stores the key in the shared data storage system in encrypted form.

8. The computing system of claim 2, wherein the computing system further includes a chaincode module that is configured to:
detect in the blockchain the indication that the remote module has imported or created the key; and
in response, automatically obtain the key from the remote module and store the key in a key manager.

9. The computing system of claim 2, wherein the local module is further configured to delay the request for the key from the remote module until the module receives an indication that the key is required for use by the computing system, such that the module only obtains the key if it is used by the computing system.

10. The computing system of claim 1, wherein the computing system further includes a chaincode module that is configured to:
detect in the blockchain ledger an indication that a remote computing system has performed the encryption key management operation; and
in response, automatically perform on the computing system a corresponding operation on the key.

11. The computing system of claim 1, wherein the computing system further includes a chaincode module that is configured to:
detect an indication that the computing system has performed, based on a client request, an encryption key management operation; and
in response, automatically record in the blockchain ledger an indication that the operation was performed, thereby notifying one or more remote computing system of the operation.

12. The computing system of claim 1, wherein the local module is further configured to:
receive from a client application a request to encrypt data;
transmit the data to a key manager for encryption;
receive encrypted data from the key manager;
transmit the encrypted data to the client application; and
record, in the blockchain ledger, an indication that the data was encrypted.

13. A method, comprising:
by a local encryption management module executing on a computing system,
receiving, via a blockchain ledger stored on the computing system, an indication of an encryption key management operation, wherein the operation is one of importing the key, creating the key, deleting the key, retrieving the key, granting authority to the key, or revoking authority to the key;
performing the operation with respect to the encryption key; and
recording, in the blockchain ledger, an indication that the operation was performed.

14. The method of claim 13, further comprising:
receiving, via the blockchain ledger, an indication that a remote blockchain encryption management module executing on a remote computing system has imported or created the key;
obtaining the key from the remote module;
storing the key in a key manager.

15. The method of claim 14, wherein obtaining the key further comprises:
recording a request for the key and an ephemeral encryption key in the blockchain ledger, such that the remote module is notified of the request and the ephemeral key via a blockchain consensus mechanism; and
receive an encrypted key via the blockchain ledger, wherein the encrypted key is encrypted by the remote module via the ephemeral key.

16. The method of claim 14, wherein obtaining the key further comprises:
transmitting a first point-to-point message to the remote module, wherein the first message includes a request for the key; and
receiving a second point-to-point message from the remote module, wherein the second message includes the key.

17. The method of claim 14, wherein obtaining the key further comprises:
obtaining the key from a shared storage system, wherein the remote module stores the key in the shared storage system in encrypted form.

18. The method of claim 13, further comprising:
receiving an indication that the computing system performed, based on a client request, an encryption key management operation; and
recording an indication that the operation was performed in the blockchain ledger, thereby notifying, via a blockchain consensus mechanism, multiple encryption management modules that the operation was performed, wherein the multiple encryption management modules each execute on a respective remote computing system.

19. The method of claim 13, further comprising:
executing chaincode on the computing system, wherein the chaincode is configured to:
detect an encryption-related operation performed by the computing system or a remote computing system;
when the encryption-related operation is performed by the computing system, automatically record in the blockchain ledger an indication that the operation was performed, thereby notifying one or more remote computing system of the operation; and
when the encryption-related operation is performed by the remote computing system, automatically perform on the computing system a corresponding encryption-related operation.

20. A non-transitory computer-readable medium that stores an encryption management module that is configured, when executed by a computing system, to perform a method comprising:
receiving, via a blockchain ledger stored on the computing system, an indication of an encryption key management operation, wherein the operation is one of importing the key, creating the key, deleting the key, retrieving the key, granting authority to the key, or revoking authority to the key;
performing the operation with respect to the encryption key; and
recording, in the blockchain ledger, an indication that the operation was performed
